(19) United States
(12) Patent Application Publication
(10) Pub. No.: US 2018/0173328 A1
(43) Pub. Date: Jun. 21, 2018

(54) HARDWARE PERIPHERAL DECODERS

(71) Applicant: Nordic Semiconductor ASA, Trondheim (NO)

(72) Inventor: Rolf AMBÜHL, Trondheim (NO)

(73) Assignee: Nordic Semiconductor ASA, Trondheim (NO)

(21) Appl. No.: 15/736,767

(22) PCT Filed: Jun. 16, 2016
(86) PCT No.: PCT/GB2016/051799

§ 371 Date: Dec. 14, 2017

(30) Foreign Application Priority Data
Jun. 16, 2015 (GB) 1510557.0

(51) Int. Cl. G06F 3/0354; G06F 3/038

(52) U.S. Cl. CPC G06F 3/0354; G06F 3/0362; G06F 3/0383

(57) ABSTRACT

An integrated circuit comprises: at least two inputs (18, 20); and a decoder (24) arranged to: sample (28) said inputs in a first cycle; sample said inputs in a second, later cycle; alter a first memory location (34) if only one of said sampled inputs changes from the first cycle to the second cycle; and alter a second memory location (46) if both of said sampled inputs change from the first cycle to the second cycle.

This invention relates to decoders for decoding inputs to a circuit, particularly, although not necessarily exclusively, a microprocessor integrated circuit, from a hardware peripheral device.

A wireless computer mouse is a common way to control a computer or laptop and these usually include a scroll wheel which can be rotated to scroll items on a screen. A typical configuration would employ an optical or mechanical motion encoder to detect movement of the scroll wheel. The motion encoder comprises an encoder wheel which is rotated by the scroll wheel.

In one arrangement the encoder wheel is situated between a light emitting diode (LED) and corresponding photodiode to interrupt the detection of light from the LED by the photodiode. However the encoder wheel has a number of radial slots formed in it which generate an output in the photodiode when aligned with the optical path between the LED and photodiode as the wheel rotates. In fact two such photodiodes are provided, offset by from each other so that the direction of motion of the wheel can be ascertained from the order in which the respective photodiodes generate an output. As an example, the photodiodes are positioned so that they are at positions which differ relative to a given part of the wheel by a quarter of the spatial repetition of the circumferentially repeating pattern of slots and solid sections. This means that whenever the scroll wheel is rotated, the signals from the photodiodes are 90 degrees out of phase with one another. The direction of rotation can then be determined by which is leading and which is lagging.

In other arrangements microswitches or other electro-mechanical contacts are used instead of LEDs and photodiodes to produce similar pulses.

The outputs from the photodiodes or microswitches of such a motion detector must be sampled and decoded to provide an input—e.g. over a short range wireless interface such as Bluetooth (trade mark)—to the host computer. This requires what is known as a quadrature decoder since it must decode two signals which are 90 degrees out of phase with one another. For example the Applicant's nRF51 series of low power, short range radio communication chips include a quadrature decoder which is arranged to decode the quadrature signals from a motion detector of the sort described above. In order to save power, the quadrature decoder module is arranged to wake up the central processing unit (CPU) only if a valid movement is detected from the sampled signals—that is a transition in output from one sample period to the next in one channel but no transition in the other channel. A consequence of this is that if an inconclusive transition occurs—i.e. if both channels transition from one sample to the next—the CPU is not woken up.

The present invention provides an integrated circuit comprising:
at least two inputs; and
a decoder arranged to:
   sample said inputs in a first cycle;
   sample said inputs in a second, later cycle;
   alter a first memory location if only one of said sampled inputs changes from the first cycle to the second cycle; and
   alter a second memory location if both of said sampled inputs change from the first cycle to the second cycle.

Thus it will be seen by those skilled in the art that in accordance with the invention, distinct memory locations are provided for noting single and double transitions. This allows, for example, action to be taken in both circumstances. The Applicant has now appreciated that in the context of the motion encoder described above for example, double transitions usually indicate that the scroll wheel has moved faster than can be sampled reliably and that in fact there may be good reasons to respond to this. For example it may be used to wake up a computer from a dormant state (as it can be deduced that a user is interacting with the device, such as a mouse, associated with the motion encoder) even if it is not used to determine scrolling of contents on a screen. Alternatively if the double transition follows a series of normal transitions in a consistent direction, a decision could be taken to interpret it as a continuation of that movement.

Moreover the invention may provide greater flexibility as it allows for different action to be taken for single transitions, which may indicate a normal input, and double transitions, which indicate an inconclusive input. For example, it could also be used to generate an error message or feedback or to increase the sampling rate to resolve the ambiguity.

In a set of embodiments the decoder is arranged to generate an interrupt signal, e.g. to a central processing unit (CPU), if the first memory location and/or the second memory location is altered.

In a set of embodiments the decoder is arranged to generate a first interrupt signal if the first memory location is written to and to generate a second interrupt signal if the second memory location is written to. In another set of embodiments the decoder is arranged to generate a first interrupt signal if the first memory location has changed over a predetermined time period (which might be a certain number of samples). Similarly the decoder may be arranged to generate a second interrupt signal if the second memory location has changed over a predetermined time period (which, again, might be a certain number of samples)

In a set of embodiments the decoder is configurable to allow a software application to determine whether an interrupt is generated in the event that the first and/or second memory location is written to and whether this is checked every sample or every N samples. The CPU may determine to read only one of the memory locations rather than both. The CPU may determine when the memory location(s) is/are cleared.

As used herein altering a memory location could comprise simply writing to the memory location. In other embodiments an operation could be performed which takes into account the value already at the memory location—e.g. adding a value to an existing value.

In a set of embodiments the first memory location comprises a first register. In a set of such embodiments a first further memory portion is provided corresponding to the first register for recording multiple values written to said first register. Said first further memory portion could simply store said multiple values separately, but in a set of embodiments it comprises an accumulator arranged to store a cumulative or resultant value, e.g. by adding newly generated values to the value currently written.

The second memory location could comprise a register. In a set of embodiments however it comprises a second memory portion arranged to record multiple values passed to it. Said second memory portion could simply store said multiple values separately, but in a set of embodiments it comprises an accumulator arranged to store a cumulative or resultant value, e.g. by adding newly generated values to the value currently written.

Provision of memory portions which record multiple values may be beneficial in allowing the CPU to read a value or values therefrom at a convenient time rather than forcing a hard time schedule on the CPU for reading the first and/or second memory location whenever a sample is taken. This may allow the CPU or indeed a whole system to operate more efficiently since the CPU is only invoked when really necessary so that it can instead remain in a dormant state or at least handle less switching and interrupt handling. The CPU may determine when the first and/or second memory location or (further) portion(s) is/are cleared.

As mentioned previously, one of the possible applications of the present invention is in opto-mechanical motion encoders which typically employ an LED or other low power light source. In a set of embodiments the integrated circuit comprises an output for controlling illumination of such a light source. This is beneficial as it allows illumination to be coordinated with the samples being taken, which reduces power consumption as the light source is only illuminated when it needs to be. For example such an output may drive an LED to be lit for a short fixed period prior to each sampling and to be switched off immediately after the inputs are sampled. Similar benefits can be achieved where the motion encoder is electro-mechanical (employing switches or contacts instead). More generally therefore, in a set of embodiments the integrated circuit comprises an output for selectively powering a motion encoder.

Although the invention has been described with particular reference to two inputs, the invention is not limited to these and three or more inputs could be provided, the principles set out above applying equally, albeit that further memory locations and/or additional further memory locations and/or interrupt sources may be required to accommodate the expanded set of possibilities of normal and 'inconclusive transitions.

An embodiment of the invention will now be described, by way of example only, with reference to the accompanying drawings in which:

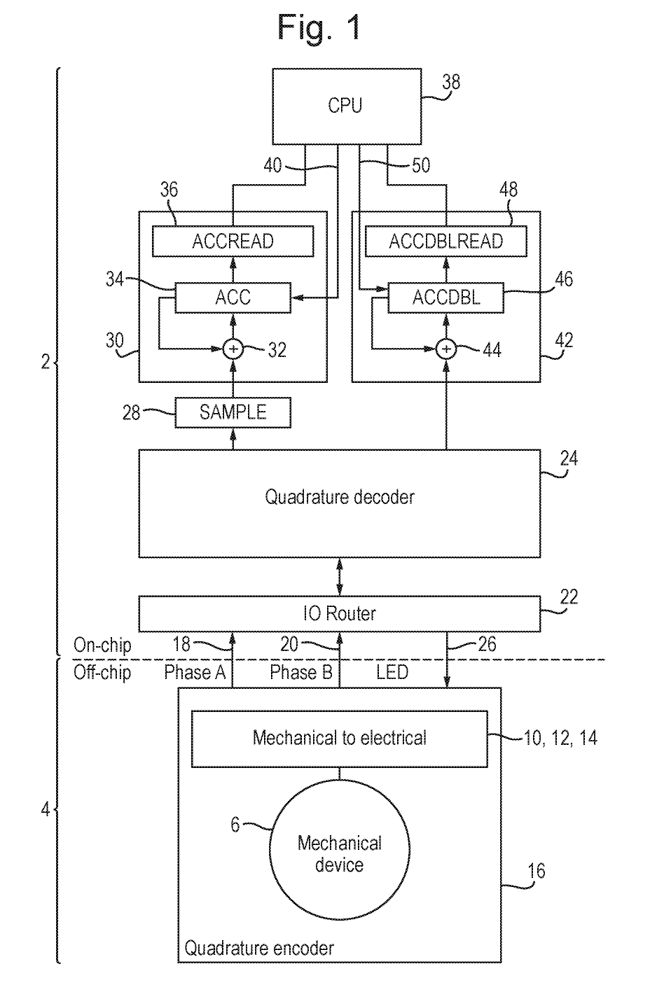

FIG. 1 is a schematic diagram of a decoder in accordance with the invention in a typical context;

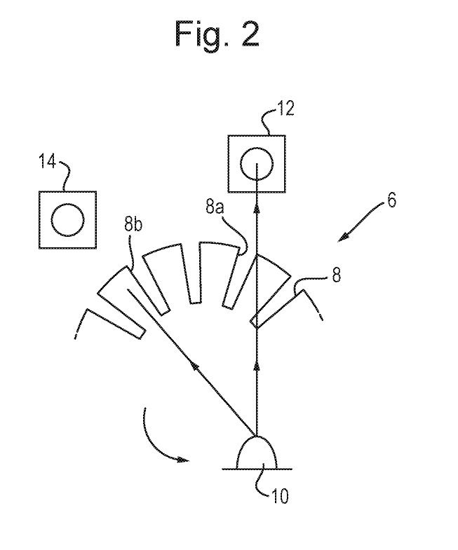

FIG. 2 is a diagram showing part of a motion decoder which may be used in accordance with the invention;

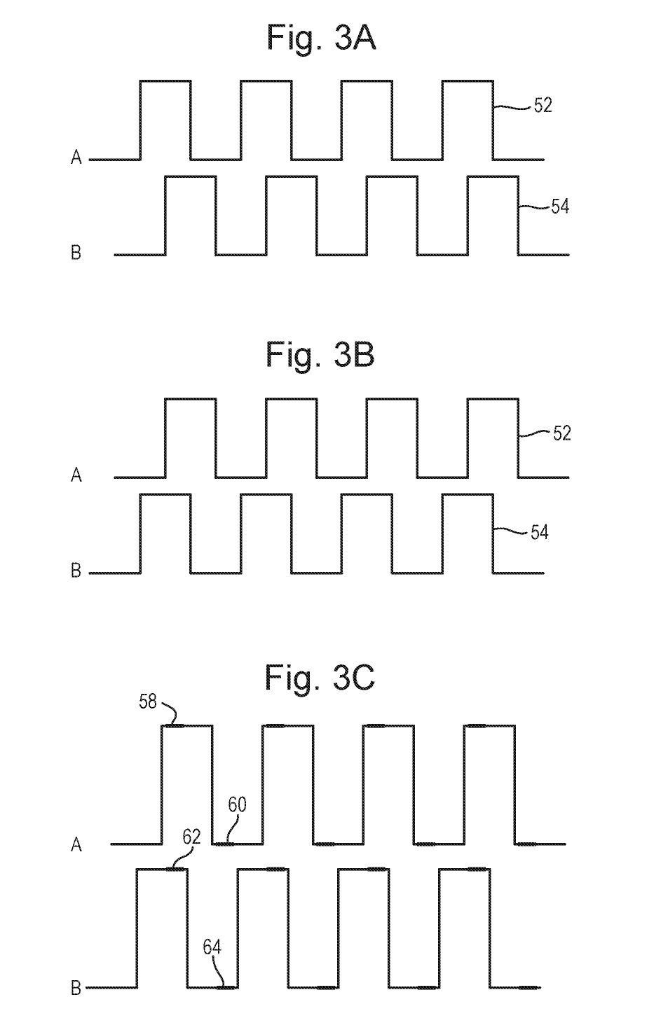

FIGS. 3A and 3B show exemplary outputs from the two photodiodes when the mouse is moved in opposite directions;

FIG. 3C shows how double transitions can arise from inadequately sampled signals; and

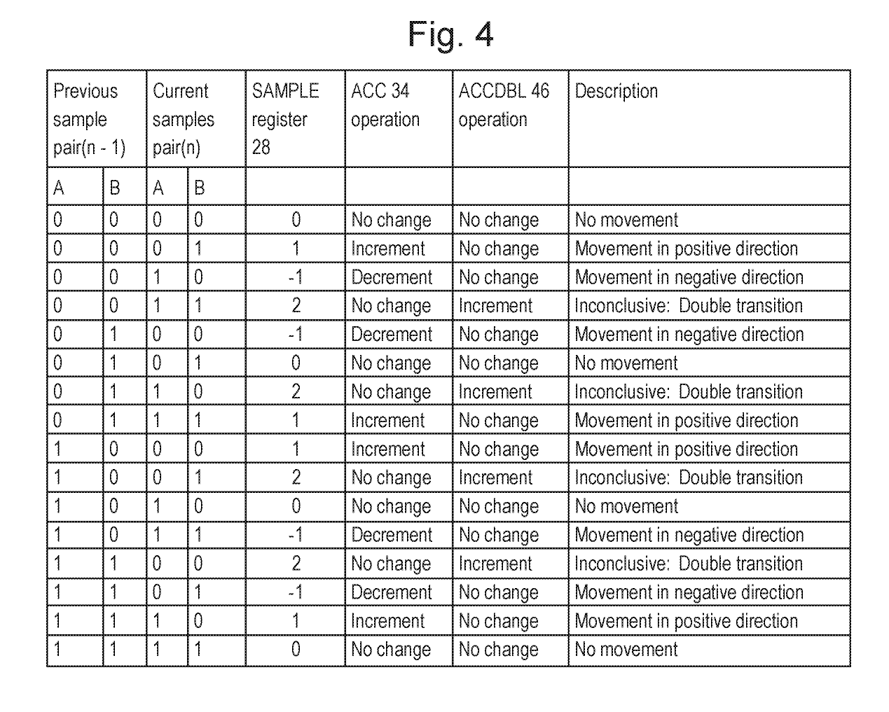

FIG. 4 is a table showing sampled values and register and accumulator contents for a decoder in accordance with the invention.

FIG. 1 shows a possible arrangement for an implementation of the invention. In this example it takes the form of a wireless computer mouse (although of course the principles would also apply where the mouse was connected to the host computer by a wire) which can be used to control a desktop or laptop computer using signals sent by means of Bluetooth™ for example. The part of the system depicted in FIG. 1 is divided into two parts: an ‘on-chip’ part 2 which is provided as part of a microprocessor on a semiconductor integrated circuit or chip; and an off-chip part 4 comprising external peripherals as described in greater detail below with reference to FIG. 2.

FIG. 2 shows diagrammatically a typical opto-mechanical motion encoder as is used on some designs of computer mouse. In these arrangements, a scroll wheel is moved by movement of the user's finger. Movement of the scroll wheel causes rotation of a slotted encoder wheel 6 shown partially in FIG. 2. The encoder wheel 6 has a number of radial slots 8 spaced around its circumference. On one side of the wheel is an LED 10 and on the other side of the wheel are a pair of photodiodes 12, 14 which are sensitive to the light generated by the LED 10. It will be seen that depending upon the rotational positions of the wheel 6 and therefore alignment of its slots 8, a light path is created from the LED 10 to one or both of the photo diodes 12, 14.

In the configuration shown in FIG. 2, light from the LED 10 is passing through a slot 8a to one of the photo diodes 12, but is prevented from passing to the other photo diode 14 by the wheel 6. However, it will be seen that if the wheel moves slightly further in an anti-clockwise direction, another slot 8b will allow light to pass through to the second photo diode 14 while light continues to pass to the first photo diode 12. Continued anti-clockwise movement will then block light to the first photo diode 12 so that it is only received by the second photo diode 14 and so on. It can be seen therefore that the signals from the photo diodes 12, 14 give an indication of movement of the encoder wheel 6 and therefore of the scroll wheel. In fact the second photodiode 14 is, in this example, spaced by 2.25 times the circumferential repetition period of the slotted pattern 8. The extra quarter period spacing means that the outputs of the two photodiodes 12, 14 are always 90 degrees out of phase with one another. The first photodiode 12 leads the second 14 when the wheel 6 turns anti-clockwise and vice-versa.

Returning to FIG. 1, the wheel 6 is illustrated figuratively as part of a motion encoder 16 which comprises components (including the LED 10 and photo diodes 12,14) for converting mechanical motion to an electrical signal. The motion encoder 16 provides two outputs 18, 20 corresponding to the signals form the photo-diodes 12, 14 respectively. The two outputs 18, 20 provide two quadrature signals A, B to the on-chip portion 2. The inputs 18, 20 are passed via a general purpose input/output router 22 which communicates with a quadrature decoder module 24. The input/output router 22 also provides an output 26 which is used to drive the LED 10 when a sample is required.

The quadrature decoder module 24 communicates with a sample register 28 which is used to record a value if a normal transition is detected from the A and B inputs 18, 20 as will be explained later. Connected to the sample register 28 is an accumulator module 30 which includes an additive combiner 32, an accumulator register 34 and an accumulator reading module 36. The accumulator reading module 36 is connected to the central processing unit (CPU) 38 to allow the CPU to read the contents of the accumulator 34. The CPU also has a clear (CLR) function 40 which allows the contents of the accumulator 34 to be cleared.

A second output from the decoder module 24 is provided to a second, ‘double’ accumulator module 42 which includes a corresponding additive combiner 44, accumulator register 46 and reading module 48 also connected to the CPU 38. There is a further CLR line 50 which can be used to clear the second accumulator register 46.

Returning to FIG. 2 and now with reference to FIGS. 3A and 3B, it can be seen that when the wheel 6 is turned, respective pulse trains 52, 54 are generated. The upper pulse train 52 corresponds to the first photodiode 12 and provides the ‘Phase A’ output 18 and the lower pulse train 54 corresponds to the second photodiode 14 and provides the ‘Phase B’ output 20 As previously explained, the distribution of the slots 8 and the location of the photo diodes 12, 14 are set so that the pulse trains 52, 54 are always 90° out of phase with one another.

FIG. 3A shows the respective pulse trains 52, 54 when the wheel is rotated in an anti-clockwise direction, whilst FIG. 3B shows the pulse trains now reversed so that the upper pulse train 52 corresponding to the phase A output 18 lags the lower pulse train 54 corresponding to the phase B output 20 as the wheel is rotated in a clockwise direction. The relative phases of the two pulse trains 52, 54 can therefore be used to determine the direction in which the wheel is rotating. It will also be appreciated that the frequency of the pulse trains can be used to determine the speed at which the wheel 6 is rotating.

Looking at FIG. 3A, it can be seen that there are two possible normal transition sequences: the first being where the A channel 52 goes from low to high followed, a quarter of a wavelength later, by the B channel signal 54 going from low to high; the second occurring at the end of a pulse when the A channel signal 52 goes from high to low followed, a quarter of a wavelength later, by the B channel signal 54 going from high to low. Of course in a given time window, both could remain low or high.

In the case of FIG. 3B, two further normal transition sequences are shown: the first being where the B channel 54 goes from low to high followed, a quarter of a wavelength later, by the A channel signal 52 going from low to high; the second occurring at the end of a pulse when the B channel signal 54 goes from high to low followed, a quarter of a wavelength later, by the A channel signal 54 going from high to low.

However, FIG. 3B shows the effect of the pulses being generated at a frequency which is too fast for the sample frequency which is set to sample them unambiguously. From here it can be seen that the A channel 18 goes from a high sample 58 in one sample period to a low sample 60 in the next sample period and even though the underlying signal for the B channel 20 is 90° out of phase, it too has a sample 62 which is high in the first sampling period followed by sample 64 which is low in the second sampling period.

What will be seen therefore is the A and B channels 18, 20 exhibiting a transition from high to low at the same time which is defined as an inconclusive transition. However, in accordance with the invention rather than discarding this it is separately counted and recorded in the double accumulator 46 which allows it to be read separately by the CPU 38 as illustrated in FIG. 1. The ability to read the standard accumulator 34 and the double accumulator 46 independently of one another has been recognised by the Applicant to be beneficial in a number of circumstances. For example, a double transition is likely to arise when the wheel is spun too quickly for the sampling rate, but this information could be used to provide continuity of input if a previous set of legal transitions had indicated that the wheel was moving in a particular direction. Or simplistically, if could simple be used to wake up a system without requiring it to be interpreted as an input to scroll screen contents or the like.

Operation of the system will now be described further with reference to the table in FIG. 4. FIG. 4 shows the various possibilities for the encoded sample values and how they may be decoded. The first two columns show the samples in the A and B channels respectively at an initial sampling time and the third and fourth columns show the samples in the corresponding A and B channels at a subsequent sampling time.

The fifth column shows the value recorded in the sample register 28 which is determined from the presence or absence of legal transitions in the samples in the A and B channels from the initial to the subsequent samples. This is explained in the last column. For example as can be seen from the second row, if channel A stays at 0 from the first to the second samples and channel B goes from 0 to 1, a value 1 is recorded in the sample register which indicates movement in a positive direction (clockwise in the example given with reference to the earlier Figs). Similarly, if channel A changes from 0 to 1 but channel B stays the same as in the third row, a value of −1 is recorded in the sample register 28 and this indicates movement in a negative direction (anti-clockwise). If there is no change in either channel A or B, a value of 0 is recorded e.g. as in the first row.

The final possibility is a double transition in which both channels A and B change value from the initial to the later sample as shown for example in the fourth row. In this situation a value of 2 is recorded in the sample register 28 to indicate the inconclusive nature of the transition.

The sixth column shows the operation of the first accumulator 34 (see FIG. 1). This is simply the result of adding the current value of the sample register 28 to the existing value of the accumulator 34 using the additive combining module 32. Therefore the accumulator 34 is incremented if the sample register 28 records a value of 1, decrements if the sample register 28 records a value of −1 and does not change if the sample register 28 records a value of 0 or 2. The accumulator 34 therefore represents a cumulative tally of the inputs received from normal transitions. It allows the CPU 38 to read the value of the accumulator 34 using the module 36 at a convenient point in time for the CPU 38 without necessarily losing the information recorded there.

Operation of the double accumulator 46 is described in the seventh column. This simply increments if a double transition is detected as, for example, in the fourth row but does not change if there is a legal transition or no transition. Again, this allows the accumulator 46 to be read at a convenient point in time for the CPU 38 if it is required to determine how many times a double transition has been recorded since the last time the accumulator 46 was read or cleared.

The system may of course include further modules (not shown) for communicating, wirelessly or over a wired connection, to a host computer inputs such as mouse movements or system wake up signals as determined by the CPU 38.

It will therefore be appreciated by those skilled in the art that at least embodiments of the invention allow a decoder for a motion encoder to record double transitions separately which allows greater flexibility in how this system is implemented and how signals from the motion encoder can be used in a practical situation. It will be appreciated though that the principles of the invention may be implemented in several different ways and are not limited to the specific embodiments described herein. For example they could be used with other motion encoders such as electro-mechanical switches or contacts and the motion encoders need not be provided in a computer mouse or even a computer interface device.

1. An integrated circuit comprising:
at least two inputs; and
a decoder arranged to:
sample said inputs in a first cycle;
sample said inputs in a second, later cycle;
alter a first memory location if only one of said sampled inputs changes from the first cycle to the second cycle; and
alter a second memory location if both of said sampled inputs change from the first cycle to the second cycle.

2. The integrated circuit as claimed in claim 1, wherein the decoder is arranged to generate an interrupt signal to the CPU if the first memory location and/or the second memory location is altered.

3. The integrated circuit as claimed in claim 1, wherein the decoder is arranged to generate a first interrupt signal if the first memory location is written to and to generate a second interrupt signal if the second memory location is written to.

4. The integrated circuit as claimed in claim 1, wherein the decoder is arranged to generate a first interrupt signal if the first memory location has changed over a predetermined time period.

5. The integrated circuit as claimed in claim 1, wherein the decoder is arranged to generate a second interrupt signal if the second memory location has changed over a predetermined time period.

6. The integrated circuit as claimed in claim 1, wherein the decoder is configurable to allow a software application to determine whether an interrupt is generated in the event that the first and/or second memory location is written to.

7. The integrated circuit as claimed in claim 6, wherein the decoder is configurable to allow a software application to determine a sampling rate at which it is checked whether the first and/or second memory location has been written to.

8. The integrated circuit as claimed in claim 1 comprising a central processing unit arranged to determine when the memory location(s) is/are cleared.

9. The integrated circuit as claimed in claim 1, wherein the decoder is arranged to alter said first and/or second memory location by performing an operation which takes into account the value already at the respective memory location.

10. The integrated circuit as claimed in claim 1, wherein the first memory location comprises a first register.

11. The integrated circuit as claimed in claim 10 comprising a first further memory portion arranged to record multiple values written to the first register.

12. The integrated circuit as claimed in claim 11, wherein the first further memory portion comprises an accumulator arranged to store a cumulative or resultant value

13. The integrated circuit as claimed in claim 1, wherein the second memory location comprises a second memory portion arranged to record multiple values passed to it.

14. The integrated circuit as claimed in claim 13, wherein the second memory portion comprises an accumulator arranged to store a cumulative or resultant value.

15. The integrated circuit as claimed in claim 1, comprising an output for selectively powering a motion encoder.
